(19) United States
(12) Patent Application Publication
(10) Pub. No.: US 2009/0100614 A1
(43) Pub. Date: Apr. 23, 2009

(54) Device for a Gangway

(76) Inventors: Leiv Andre Dale, Ravnanger (NO); Lars Bjoland, Agotnes (NO); Bjorn T. Akselsen, Soreidgrend (NO)

Correspondence Address: Carella, Byrne, Bain et al, 5 Becker Farm Road, Roseland, NJ, 07086-1739, US

(21) Appl. No.: 11/885,098

(22) PCT Filed: Jan. 24, 2006
(86) PCT No.: PCT/NO2006/000032

§ 371 Date: Jul. 3, 2008

(30) Foreign Application Priority Data
Jan. 24, 2005 (NO) 20050361

(51) Int. Cl. E04G 1/22; B63B 27/14; E04G 5/10; E06C 7/18; E04G 7/00

(52) U.S. Cl. 14/71.3; 182/101; 182/69.6; 114/362; 14/72.5; 182/106

(57) ABSTRACT

A device for a gangway construction is described, which is characterised in that it is composed of a number of sections, each comprising a polygonal frame, one connected to the frame formed as a landing, and a gangway, the one end of which is hinge-connected to the frame/landing while the other end is set up to rest against the frame/landing of an underlying frame, and the construction is arranged to be readjusted between a folded position where the sections are lying on top of each other, as in a stack of frames, with each gangway inserted in the frame, and an active, using position where the frames are set up a distance apart so that the gangways form a suitable angle between adjoining landings/frames. Also described are a section for building a gangway construction, a railing construction and also applications of the invention.

The present invention relates to a device for a gangway as described in the ingress of the subsequent claim 1.

Furthermore, the invention also relates to a unit that can be used in the building of a gangway according to the invention. Additionally, the invention relates to a variant of the unit for building a gangway.

In addition, the invention relates to a device for a railing in connection with the above mentioned gangway.

The invention also relates to an application of the device.

In particular, the invention concerns a gangway that can be used as an escape route, such as from an offshore installation (i.e. passage of people) from a building or the like and vertically down to a base. Such a base can be ground level, a life raft, rescue ship or vessel. The gangway system can, of course, be used in the opposite way, i.e. that it is used for passage of people from the base and up to the installation. The invention concerns a gangway system that can be readjusted from a storage position to a using position, i.e. that it can be folded into a stack, and be folded out into a using position.

With gangway system one means more specifically a staircase system, but the staircase element itself can, of course, be replaced by a platform that can be tilted whereupon people can walk down or up between the “floors” in the gangway system. Thus, it can also be used by wheelchairs and the like. However, for simplicity, the designation staircase system is used when the invention is described.

A collapsible staircase construction is known from U.S. Pat. No. 4,707,957, comprising an upper and lower frame and two connected stairways. However, in this construction, one of the stairways is rigidly connected to an upper and lower frame, respectively, while the other stairway swings freely to the lower frame part. This means that when the construction is folded together, the upper frame part is displaced horizontally with respect to the lower frame part. This staircase construction is meant to be fitted permanently between two floor levels. The aim of this construction is different from the aim of the present invention.

It is an aim of the invention to provide a new construction for a gangway (staircase system) that can form a continuous escape route from an installation or building from any height above a base.

It is also an aim of the invention to provide a gangway (staircase system) that can move from a storage position to a using position.

It is also an aim of the invention to provide a gangway (staircase system) that is of a simple, yet robust, construction, and which is simple to readjust between the two positions.

Furthermore, it is an aim of the invention to provide a gangway section unit (staircase section unit) that can be used to construct gangway systems (staircase systems) with an optional number of units, to be able to regulate the total user height of the gangway between its inlet section on the installation and its exit section on the base.

The gangway according to the invention is characterised in that it is composed of a number of sections, each comprising a polygonal frame, one in connection to the frame forming the landing, and a gangway, the one end of which is hinge-connected to the frame/landing while the other end is arranged to lie against the frame/landing of an underlying frame, and the construction is arranged to be readjusted between a folded position where the sections are lying on top of each other, as in a frame stack, with each gangway inserted in the frame and an active, using position where the frames are readjusted a distance apart so that the gangways form a suitable inclined position between the adjoining landings/frames.

The particularly preferred embodiments-of the gangway system appear in the independent claims 2-11.

The section for building up a gangway construction is characterised by a polygonal frame, one in connection to the frame formed as a landing (a transfer platform), and a gangway, the one end of which is hinge-connected to the frame/landing, and the section is arranged for the connection of means for raising and lowering, and also for placing the gangway at a correct angle. The preferred embodiments are given in the claims 13-15.

The railing construction for a railing in connection to the gangway construction that comprises a polygonal frame, a landing (a transfer platform) and a gangway, the one end of which is hinge-connected to the frame/landing, and the section is arranged for connection of means for raising and lowering, and also for placing the gangway at a correct angle, is characterised in that two railings, one on each side of the gangway, are connected to the staircase string board and frame, respectively, so that it can swing, such that the readjustment between folded railing position and extended using position occurs in step with the readjustment of the gangway construction. The preferred embodiments of the railing are given in claims 17-20.

According to the invention, the device is used as a collapsible staircase section to be used during rescue or evacuation operations (evacuation) between buildings and a base, and/or between installations/platforms/ships/ and rescue vessel/fleet/vessel.

The invention shall now be described in more detail with reference to the enclosed figures, in which:

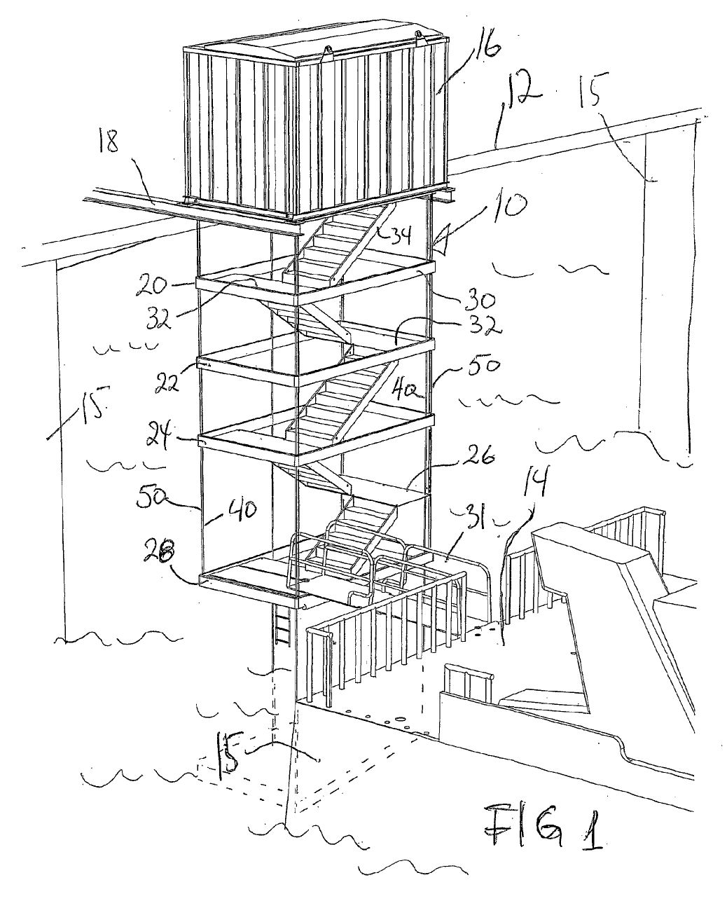

FIG. 1 shows the gangway in a using position between an offshore platform and a supply vessel for transfer of people between platform and vessel. The gangway construction is mounted in a housing formed in a cantilever on the platform.

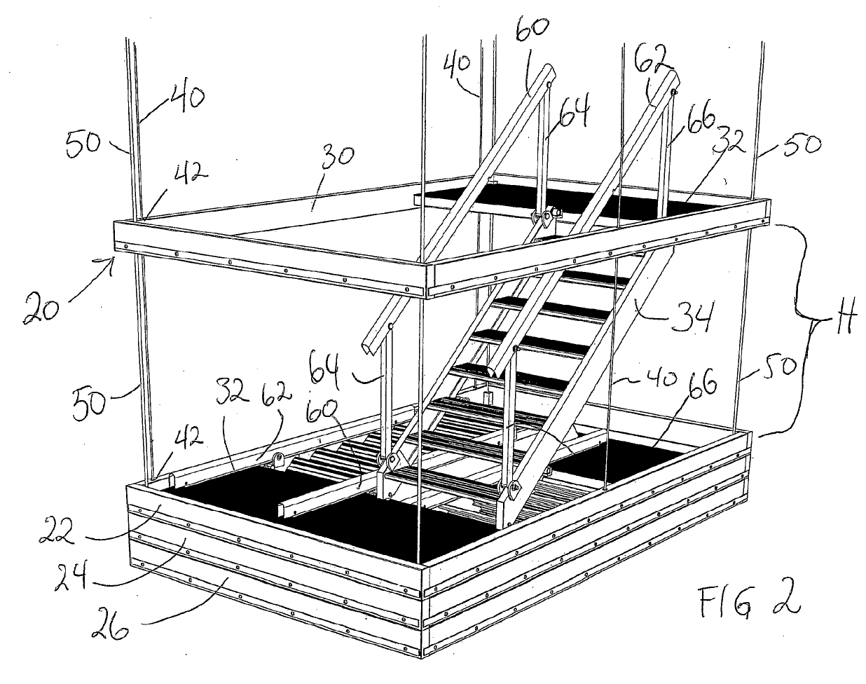

FIG. 2 shows the gangway construction during its initial lowering from the housing on the platform.

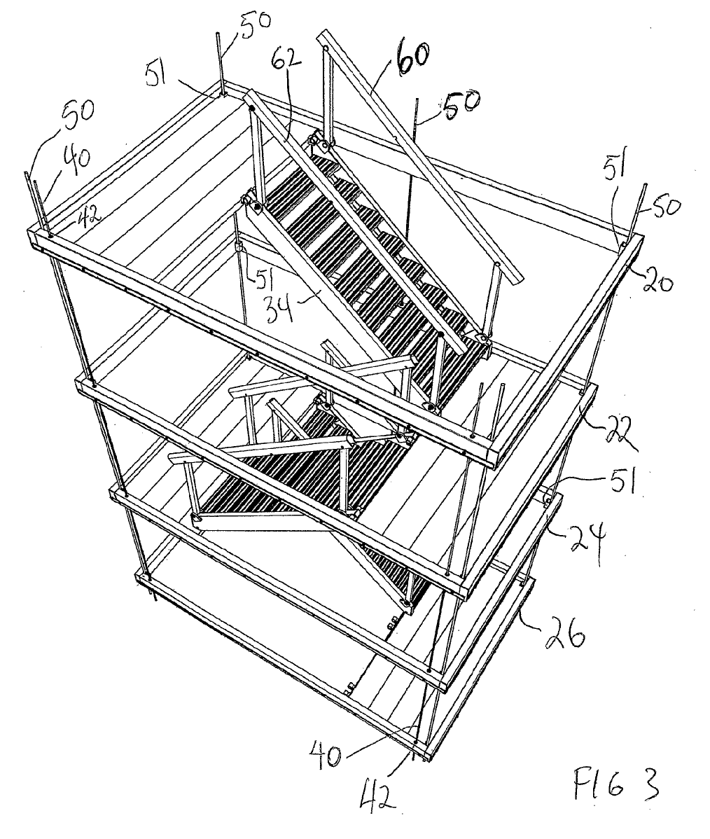

FIG. 3 shows the gangway construction according to FIG. 2 in fully extended (lowered) position.

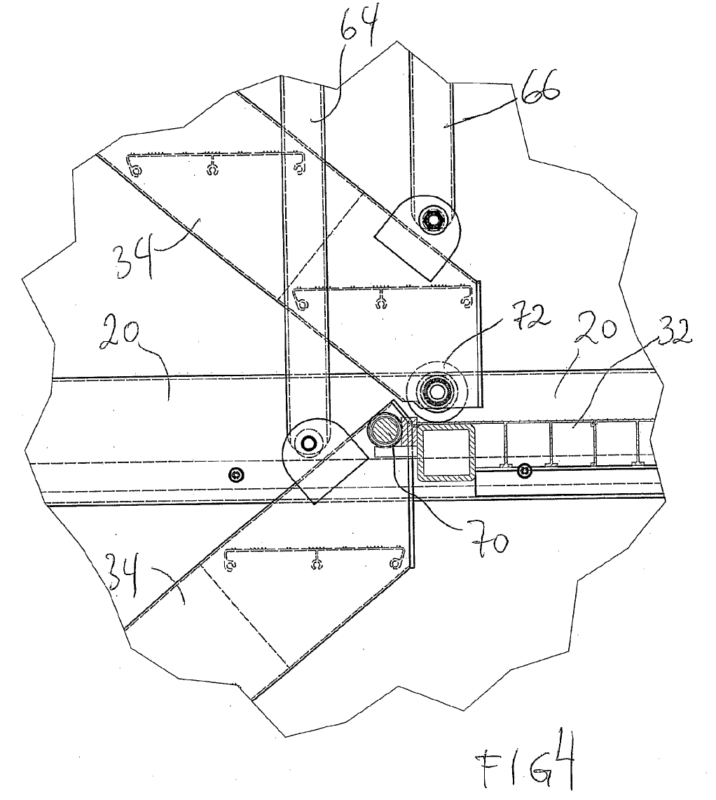

FIG. 4 shows details of the hinging of the staircase construction and also how the underside of the staircase can roll on the landing that constitutes the transfer platform between two adjoining stair ways.

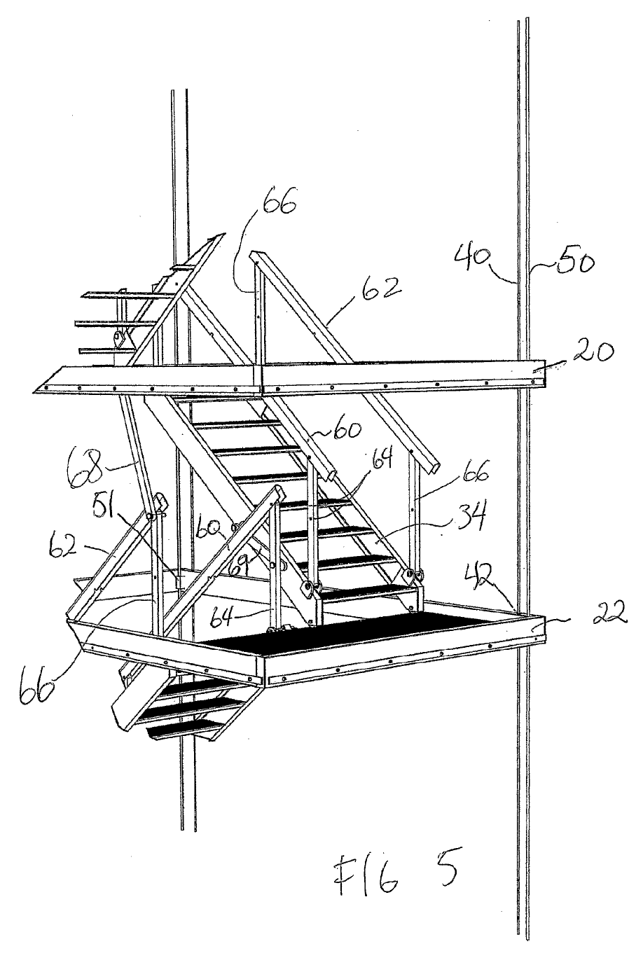

FIG. 5 shows the principle for mounting (raising and folding) of the banister or railing.

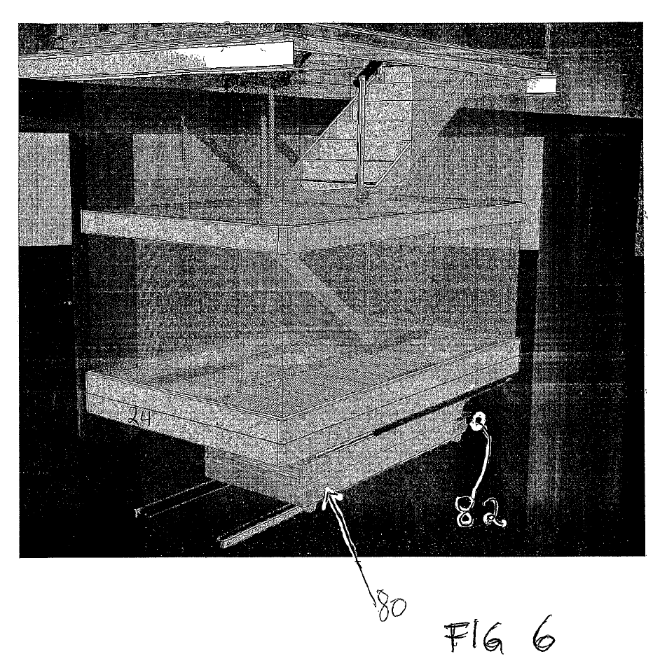

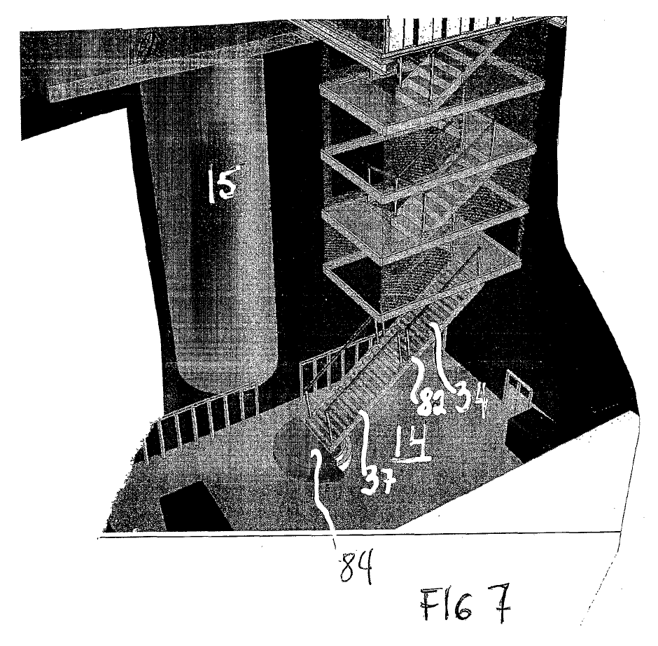

FIGS. 6 and 7 show the stairway during the use of a collapsible staircase from a bottom section of the system.

Initially, reference shall be made to FIG. 1. The gangway construction 10 is shown in its using position where it runs between an offshore platform 12 and the deck 14 of a supply vessel 15 for transfer of people between platform 12 and vessel 15. The platform columns are indicated by 15.

In its folded position, the gangway construction is mounted inside a housing 16 built on a cantilever 18 on the platform, i.e. it can be displaced from a protected position inside the platform to a position extending outside the edge of the deck of the platform. The construction is thereby protected against the weather and ready to be pushed out as shown in FIG. 1.

At the top, entrance to the gangway will be via the housing 16 to the upper staircase section, and leaving the gangway can be via a separate gangway from the vessel 15. This gangway can then be led onto the bottom landing of the section. It is most practical that the bottom section comprises its own gangway or gangplank to enable departing. The traffic can, of course, take place both ways.

Reference is made to FIG. 2 that by the reference number 20 shows the unit section 20 that the construction is based on. In the figure, four such sections are shown at 20,22,24,26, each encompassing a frame 30, a landing 32 (as a transfer platform) and a staircase unit 34. In storage position, the staircase 34 lies flat, placed inside the frame so that the height of the frame beam 30 forms the vertical extension of the sections. The three bottom sections 22,24,26 show the appearance of such a frame stack.

The frame 30 is preferably a frame construction with a square plane section, although other plane sections can be used. The frame is constructed from beam elements. Inside each frame, at the one short end, a plate-formed landing is formed by the frame. By further reference to FIG. 7, the landing forms a mounting for the upper end of the staircase section 34 of the section, via a hinge 70. The bottom staircase end is formed with wheels 72 underneath each staircase string board so that it can roll or glide on the landing 32 of the underlying section, both when the gangway is pushed out into using position and when it is folded into storage position. When the sections are folded into a stack, the staircase 34 lies flat inside the frame 30, as shown in FIG. 2. The landing has a further length adapted so that (see FIG. 7) when the gangway is in using position, the staircase forms a suitable angle, for example, 40° down to the underlying landing and the lower end of the staircase 34 with the wheel stands adjoining the upper edge of the underlying staircase.

The staircase shaft shown in FIG. 2 is in position for lowering or raising. The three bottom sections are folded with their own staircase inside the respective frame while the upper section is extended so that the staircase 34 is folded and rests on the landing 32 of the underlying section.

The four sections lying on top of each other are mutually connected via a number of lifting wires 40 that run between a winch system (not shown) inside the housing 16 and a mounting (not shown in detail) on the underside of the bottom section 26. The wires run freely through holes/grooves 42 through the frame 30 of all the four sections.

Four such wires 40 can be used, for example, one for each corner of each section, or additional wires, running down through individual holes in the middle of the longitudinal beam 30.

To ensure that the distance between two adjoining sections 20,22,24,26 is correct, and the staircase gets the desired angle, between each section, i.e. between each of their adjoining corners, a separate spacing wire 50 with distance H, is placed. This wire is shown secured to the frame 30 at an anchorage point 51 as can be most clearly seen in FIGS. 3 and 5. When, during lowering, the section 20 is in correct position and the stack 22,24,26 continues to be lowered, the section 22 will follow down until the wire 50 is fully extended. Then, the section 22 has the desired position, it is in place and the rest of the stack is lowered during the continued lowering. Then, the section 24 and thereafter the section 26 are positioned. In FIG. 1, the section 26 is not shown, apart from its landing 32 and staircase 34. The wire 40 is fastened to the lowest bottom section 28, and the departure from this section can be formed by the gangway of the ship or by the section 26 having a separate gangway installation. In this text, wire is used as an example, as other types of lifting-lines, such as rope or chains (rope for the simpler cases with few sections) can be used. But using wires is the most appropriate.

FIG. 2 also shows that the staircase encompasses a railing or banister 60 and 62 respectively, on each side of every stairway. The railing of section 20 is in an inclined position in step with the angle of the staircase, while the railing of the underlying section 22 is swung and displaced horizontally over the landing 32. Each banister is rotary connected with the respective vertical stays 64 and 66, respectively, that extend upward from each end of every staircase string board. The stays 64 and 66, respectively, are furthermore mounted to the staircase string board 34 so that they can swing.

As can be seen in FIG. 5, the (first) outer railing is connected with the overlying section frame via the one end of a stay 68, while the other stay end 68 is fastened to the banister 62. A second stay 69 connects the (second) inner railing 60 with the overlying staircase string board. It can be seen that the second stay runs at an angle with a small deflection from the horizontal direction. When the overlying staircase is folded to lie horizontally, it pushes, at the same time, the railing 60 forward to the horizontal position that is shown in FIG. 2. The stay 68 will have a corresponding pushing force on the outer railing 62 which is also pushed horizontally forward when the sections are folded. When the gangway is readjusted to using position, the railing is raised in step with the staircase sinking down under an overlying section to which the stay is secured, and correspondingly, that the staircase string board moves relatively upwards in relation to the railing.

According to an alternative embodiment, the sections can be clad externally with a collapsible net between each section.

According to the invention, the system is hoisted into the container 16 with the help of the winch and a steel wire fastened to the lower section or an underlying stabilising weight. Staircase and railing are then parked horizontally inside associated section units.

It can be seen that the gangway is composed of a number of identical sections, in which alternate sections are turned 180°. Thus, a Z-formed stairways is formed.

It can be seen in the FIGS. 6 and 7 that the bottom section can comprise two staircase sections 34 and 37, which can fold, that are connected together via a hinged joint 82. FIG. 6 shows the staircases folded, while FIG. 7 shows the staircases pivoted and extended in a downward, inclined position to an exit platform 84 on the deck 14.

According to an alternative embodiment, the landing can continue on the side of each section, along the overlying staircase string board, and to the next staircase that runs at the same angle as the overlying and the underlying staircases. Thereby, all the stairways run in the same direction. But from a rescue perspective, this solution is less preferred as it takes much more time to walk/run from one staircase to the next one. Furthermore, this construction is more complex than the one that is described initially, and it can represent a weight-imbalance in the construction.

A bottom frame part can function only as a sinking element and in itself be lowered down into the sea if the staircase construction is used as a gangway from a ship or platform and the like. This will stabilise the construction in its using position. When the construction is in a storage position, it is stored inside the housing/container 16 that also functions as a house of entry for the staircase shaft.

1. Device for a gangway construction comprising a plurality of sections, at least one of said sections including a polygonal frame, a landing, and a staircase, said staircase having one end hinge-connected to said frame while the other end is arranged to rest against said landing, and the construction is set up to be readjusted between a folded position where said sections are lying on top of each other with said staircase inserted in said frame, and an active use position where said frame and said landing are set a distance apart so that the staircase forms a suitably inclined position between said frame and said landing.

2. Device according to claim 1, characterised in that the readjustment is carried out by a number of lifting wires that run between a winch system and a mounting on the underside of the lower/bottom section, said wires run freely through one of holes and grooves through the frame material to all the four sections and such that when the wires are lowered, the section is readjusted to said use position, while when the wires are pulled in, the section is readjusted to said folded position as a stack of frames.

3. Device according to any one of claims 1 and 2, characterised in that the correct mutual distance between the sections is maintained in that each end of a number of lines with a given length, are fastened a mutual distance apart between two adjoining sections.

4. Device according to any one of claims 1 and 2, characterised in that the lower end of the staircase comprises free-running wheels that can roll on said landing floor during the readjustment.

5. Device according to any one of claims 1 and 2, characterised in that the upper section of said sections forms a gangway connection to an installation while a bottom section of said sections forms a gangway connection with a vessel.

6. Device according to any one of claims 1 and 2, characterised in being composed of a number of identical frame sections, where every alternate frame is turned I 80°, so that a Z-shaped gangway path is formed.

7. Device according to claim 1, characterised in that each section of a plurality of adjacent sections includes a frame, a staircase and a landing wherein said frame of one of said sections forms a landing of an adjacent section thereabove and said landing of said one section forms a frame of an adjacent section therebelow.

8. Device according to claim 7, characterised in that each staircase comprises a pair of railings, one on each side of the stairway and which are readjusted between said folded position and a fully extended position in step with the readjustment of the device.

9. Device according to claim 8, characterised in that an inner railing of said pair of railings is connected to an overlying, adjoining staircase string board via a stay while outer railing of said pair of railings is connected to an overlying, adjoining section frame to provide the readjustment of said pair of railings.

10. Device according to claim 9 characterised in that the landing runs further along the overlying staircase string board on the side of each staircase section up to the other end of the frame, where the following staircase is hinged and thereby runs at the same angle as the overlying and the underlying staircases, whereby all the stairways lie in the same direction.

11. Device according to any one of claims 1 and 2 characterised in that the sections of frames are arranged to be stored as a frame stack in a housing on the installation.

12. Section for building a gangway construction, characterised in having a polygonal frame a gangway hinge-connected to said frame, and means conneted to said frame and gangway for raising and lowering, and also for setting said gangway at a correct angle.

13. Section according to claim 12, characterised in that the gangway is a staircase.

14. Section according to claim 13, characterised in that the staircase comprises a pair of railings, one on each side of the stairway, and that are readjusted between folded and fully extended position in step with the readjustment of the staircase.

15. Section according to claim 14, characterised in that an inner railing of said pair of railings comprises a stay to promote the readjustment of the railings.

16. Device for a railing in connection with a gangway construction that comprises a polygonal frame, a landing and a staircase, each respective end of said staircase being hinge-connected to each of said frame and said landing, and the section is set up for the connection of means for raising and lowering, and also for readjusting the staircase to a desired angle, characterised in that the two railings, one on each side of the staircase path, are respectively connected to the staircase string board and frame, respectively, so that they can swing, such that the readjustment between a folded railing position and a fully extended position, is in step with the readjustment of the gangway construction.

17. Device according to claim 16, characterised in that a first, outer railing is connected to the overlying section frame via one end of a stay, while the other stay end is fastened to the banister, while a second stay connects a second, inner railing to the overlying staircase string board.

18. Device according to claim 17, characterised in that the second stay runs at an angle, with a small deviation from the horizontal direction.

19. Device according to claim 18, characterised in that when the overlying staircase is folded to lie horizontally, the railing is pushed forward to a horizontal position at the same time.

20. Device according to claim 19, characterised in that the stay forms a pushing force on the outer railing which is also displaced forward horizontally when the sections are folded and when the gangway is readjusted into a using position, the railing is raised up in step with the staircase sinking down below an underlying section to which the stay is fastened, and correspondingly, that the staircase string board moves relatively upward in relation to the railing.

21. (canceled)
